(19) United States
(12) Patent Application Publication
(10) Pub. No.: US 2008/0072753 A1
(43) Pub. Date: Mar. 27, 2008

(54) Grease filtration unit for kitchen exhaust hoods

(76) Inventors: Bruce Lukens, Newberg, OR (US); Russell Robison, Yamhill, OR (US); Joseph A. Salpietra, Shreveport, LA (US); Todd Randinelli, Bonita Springs, FL (US)

Correspondence Address: THOMPSON HINE LLP;Intellectual Property Group, P.O Box 8801, DAYTON, OH, 45401-8801, US

(21) Appl. No.: 11/799,050

(22) Filed: Apr. 30, 2007

Related U.S. Application Data
(60) Provisional application No. 60/796,240, filed on Apr. 28, 2006.

(51) Int. Cl. B01D 50/00; B01D 46/00

(52) U.S. Cl. 95/273; 55/385.1

(57) ABSTRACT

A grease filter unit includes a frame assembly and a filter material. The frame assembly includes a front frame member and a back frame member, with the filter material held between the two frame members.

### CROSS-REFERENCE TO RELATED APPLICATIONS

This application claims priority to U.S. Provisional Application No. 60/796,240, entitled “Grease Filtration Unit for Kitchen Exhaust Hoods,” filed Apr. 28, 2006, the details of which are hereby incorporated by reference in their entirety.

### TECHNICAL FIELD

This application relates generally to exhaust hoods utilized in kitchens of commercial establishments such as restaurants and cafeterias and, more particularly, to a grease filtration unit that can be use in connection with such hoods.

### BACKGROUND

Kitchen ventilator exhaust hoods have long been provided for the purpose of exhausting steam, smoke and particulates such as grease that are produced by cooking appliances, such as broilers, in the commercial cooking environment. Many such hoods currently incorporate one or more UL 1046 baffle units through which exhaust air passes. Such baffle units cause air to turn and, as a result, some grease is flung out of the exhaust flow. Removal and cleaning of such baffle units can be cumbersome.

U.S. Pat. No. 6,293,983 suggests the use of a filter in front of such baffle units to filter out grease. The suggested filter material is formed primarily of wool, but other filter materials could be used. The filter material can be replaced from time to time when the amount of grease on the filter material reaches an undesired level. Use of the filter reduces the need for cleaning of the baffle units.

In filtration units, it is important to assure that the filter material, or portions of it, do not separate from the hood and drop onto the cooking surface, as the same may prevent a filter from passing applicable tests, such as UL 1046 and UL 710 guidelines.

### SUMMARY

In one aspect, a grease filter unit includes a frame assembly and a filter material. The frame assembly includes a front frame member and a back frame member, with the filter material held between the two frame members.

In another aspect, a latching mechanism may be provided to aid in holding the front frame member to the back frame member. A pivoting action may be provided on one edge as between the front frame member and the rear frame member.

A variety of filter materials may be used. In one instance the filter material may take the form of fiber blanket formed of wool fiber. In other instances other natural or man made fibers may be used.

In another aspect, a grease filtration unit such as described above is incorporated into a kitchen exhaust hood.

### BRIEF DESCRIPTION OF THE DRAWINGS

FIG. 1 is an exploded, perspective view of an embodiment of a grease filter unit;

FIG. 2 is a partial, rear view of an embodiment of a back frame member for use in the grease filter unit of FIG. 1;

FIG. 3 is a rear view of an embodiment of a front frame member for use in the grease filter unit of FIG. 1;

FIG. 4 is a partial, perspective view detailing a U-shaped channel of the front frame member of FIG. 3;

FIG. 5 is a diagrammatic view of the back frame member of FIG. 2 having an edge in the U-shaped channel of FIG. 4;

FIG. 6 is a detail view of the back frame member of FIG. 2;

FIG. 6A illustrates area A of the back frame member of FIG. 6;

FIG. 7 is another detail view of the back frame member of FIG. 2;

FIG. 8 is a detail view of the front frame member of FIG. 3;

FIG. 9 illustrates a connection between the front frame member of FIG. 3 and the back frame member of FIG. 2;

FIG. 10 is a diagrammatic illustration of the grease filter unit of FIG. 1 being assembled and placed within a hood;

FIG. 11 is a plan view of another embodiment of a front frame member; and

FIG. 12 is a plan view of another embodiment of a back frame member capable of being used with the front frame member of FIG. 11.

### DESCRIPTION

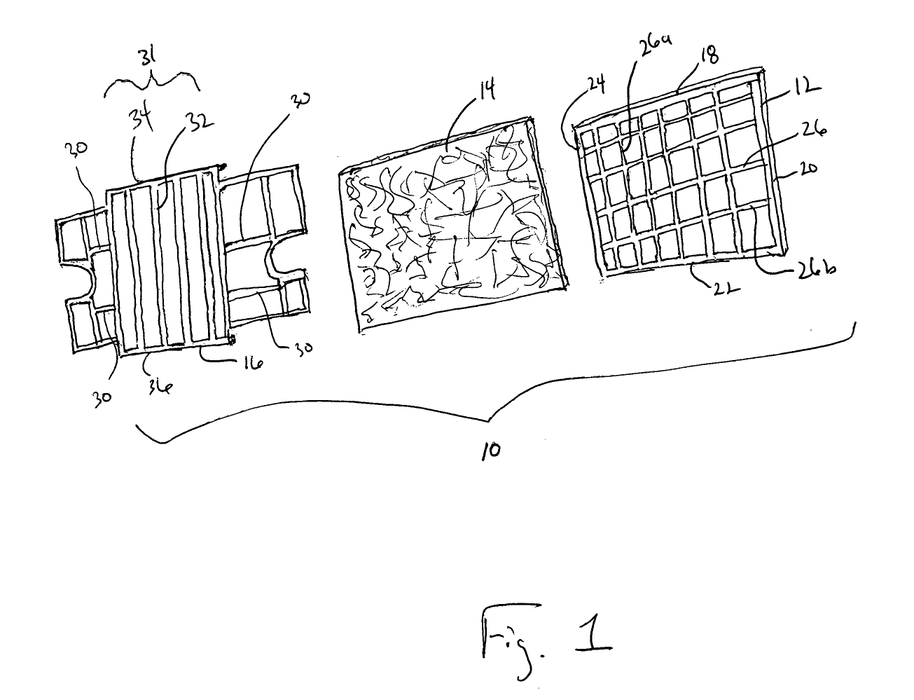

Referring to FIG. 1, a three part grease filter unit 10 is shown and includes a back frame member 12, a filter material 14 (e.g., woven, non-woven, etc.) and a front frame member 16. The terms “front” and “back” or “rear” are used herein relative to the intended direction of air flow through the filter unit 10 from front to back.

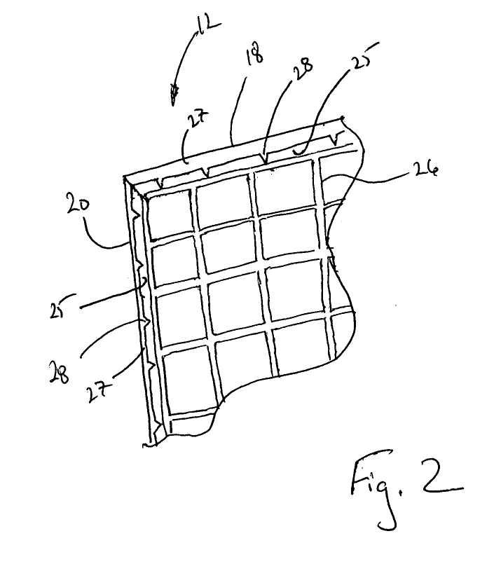

The back frame member 12 is made up of four generally rigid edge members 18, 20, 22 and 24 connected by a grid or latticework 26 of slats. The latticework 26 supports the filter material 14 during air flow through an assembled unit. In one embodiment, referring also to FIG. 2, the back frame member 12 is formed of a sheet of steel, aluminum or other metal, the edges of which are bent to create u-shaped channels 25 that form the edge members 18, 20, 22 and 24. The grid, which may be unitary with the edge members, is formed by cutting or stamping away sections of the metal sheet leaving top to bottom 26a and side to side 26b metal slats. The rear leg 27 of each U-shaped channel may include spaced apart teeth 28 extending therefrom. When assembled, the edges of the filter material may be wrapped around the edge members 18, 20, 22, 24 and engaged by the teeth 28 to aid in holding the filter material to the back frame 12.

The front frame member 16 may also be cut from sheet metal and is configured to engage the back frame member 12 so that the filter material may be sandwiched therebetween, with sufficient open space in the frame member 16 such that a majority of the filter material 14 does not become overly compressed. As shown in FIG. 1, it is generally preferred that the configuration of the front frame member have only a small number of horizontal slats 30, with a substantial majority of the slat work of frame member 16 being oriented top to bottom as are slats 32. In the illustrated embodiment, with the exception of edges 34 and 36, the slat work in a central region 31 (e.g., the middle 50% from side to side) of the frame member 16 lacks any side to side slats. The use of top to bottom slats, as opposed to side to side slats, in the front frame member 16 aids in reducing the opportunity for filtered grease to build up on side to side slats and drip back down on a cooking surface. Specifically, any grease that collects on top to bottom slats will tend to run down the slats under the force of gravity and can be collected in a suitable rail or other structure supporting the bottom of the filter unit.

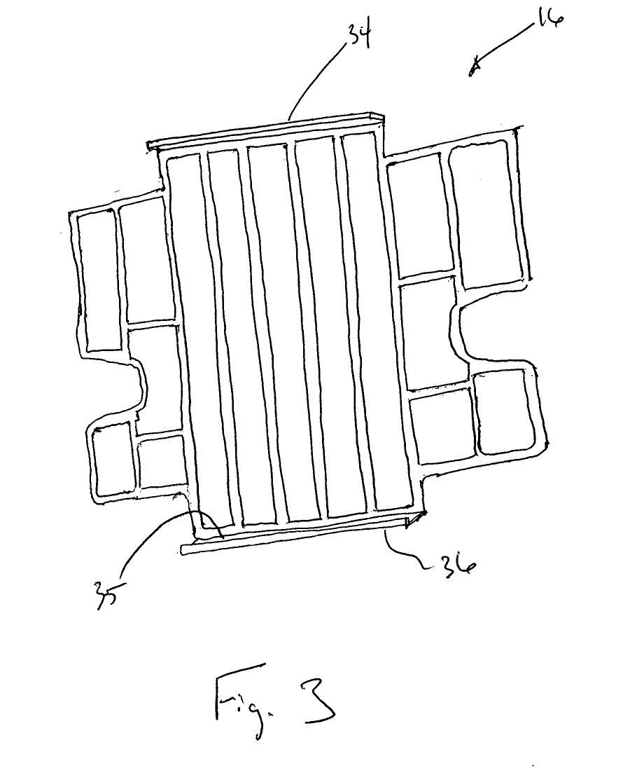

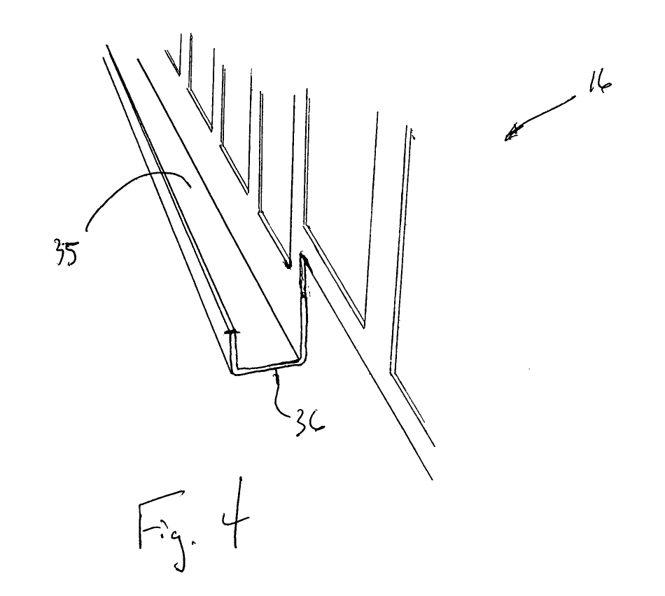

FIG. 3 depicts a rear view of the front frame member 16. Edge 34 includes an L-shaped bend and edge 36 includes a U-shaped bend forming a channel 35, as more clearly seen in FIG. 4. The channel 35 is sized to receive one edge member of the back frame member 12 therein and to permit some pivotal movement between the front and rear frame members as shown in FIG. 5. In this orientation the back frame member 12 can be freely moved in and out of the U-shaped channel 35 of the front frame member 16.

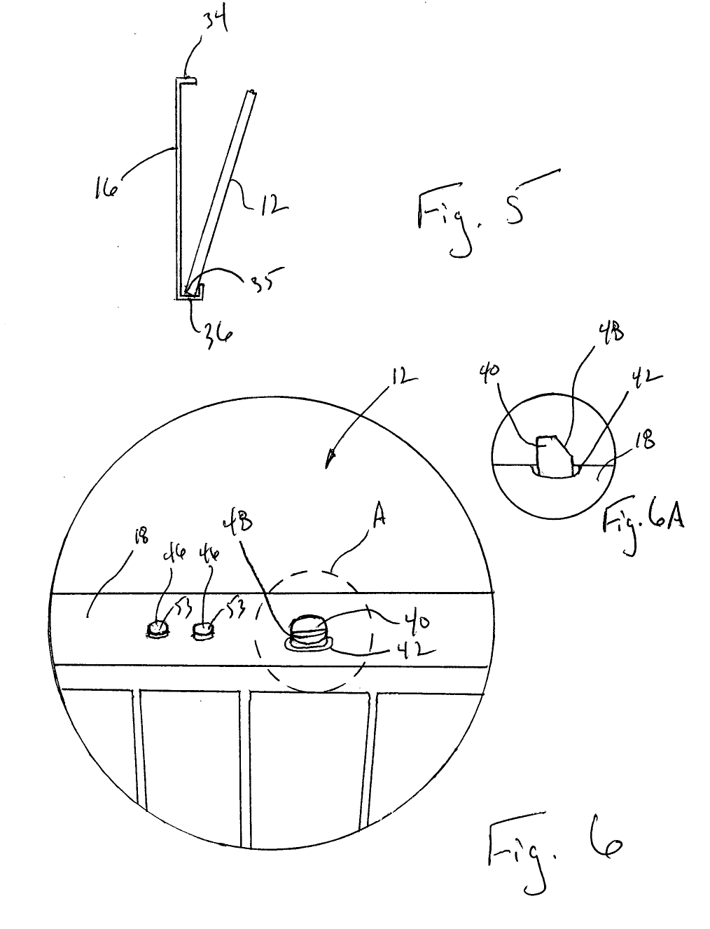

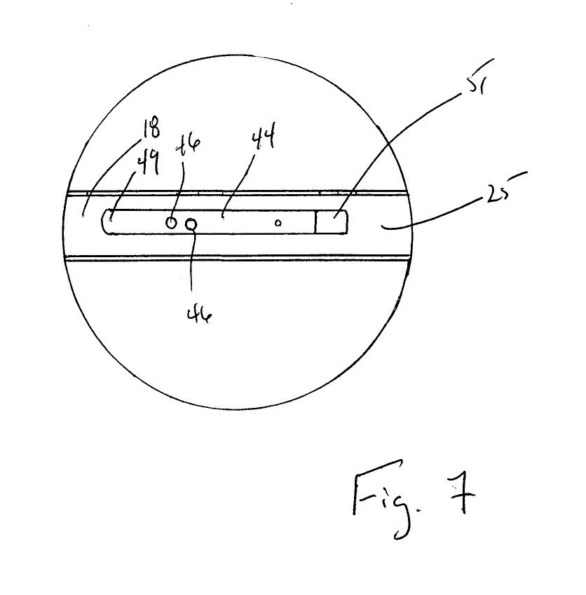

Referring now to FIGS. 6, 6A and 7, enlarged top and bottom views of the edge member 18 of the back frame member 12 are shown. Referring first to FIG. 6A, the edge member 18 includes an associated latch 40 that is outwardly biased, but which can be depressed. In the illustrated embodiment, edge member 18 includes an opening 42 through which the pin latch 40 extends. Referring to FIG. 7, the pin latch 40 is connected to a leaf spring member 44 within the U-shaped channel 25 of the side member 18. One end 49 of the leaf spring member 44 is fixed to the edge member 18 (e.g., as by rivets 46, other fasteners or weld points). The other end 51 of the leaf spring member 44 is free to move when sufficient force is applied to the pin latch 40. This latch may be referred to as a snap button. Referring to FIG. 6A, the pin latch 40 may have a ramped surface 48, with the ramp running from front to back (i.e., with the lower edge of the pin toward the front of the frame member).

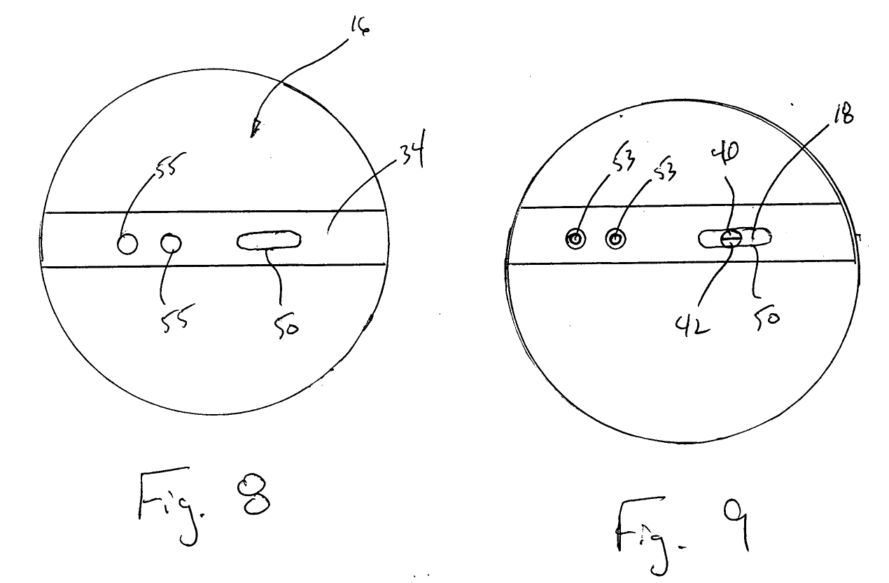

As shown in FIG. 8, the front frame member 16 includes a slot 50 in edge 34, the slot configured to receive and engage with the latch pin 40 when the two frame members are pivoted toward each other out of the open pivot configuration shown in FIG. 5. The edge 34 also includes two openings 55 that are configured to receive extended ends 53 (e.g., dome-shaped extended ends) of rivets 46. As the leg of L-shaped member 34 slides over the edge member 18, the leg engages with the ramp surface of the pin latch 40 through the filter media causing the pin latch to depress until the slot 50 aligns with the pin latch and the leaf spring causes the pin latch 40 to move outwardly into the slot 50 as shown in FIG. 9 (filter material left out for clarity), at which point the engagement of the pin latch 40 and slot 50 aid in holding the frame member in an assembled configuration.

The subject grease filtration unit may be installed in existing kitchen exhaust hoods upstream of UL 1046 baffle units via suitable supports on the hood into which the unit can be inserted. The use of the front frame member 16, in combination with the back frame member 12, to hold the filter material 14 therebetween in a sandwiched manner reduces the likelihood of filter material dropping onto the cooking surface. The pivoting action and latching mechanism facilitate simple replacement of spent filter material.

While the illustrated embodiment contemplates the latch on edge 34 of the back frame member 12, it could be located on one of the other edges.

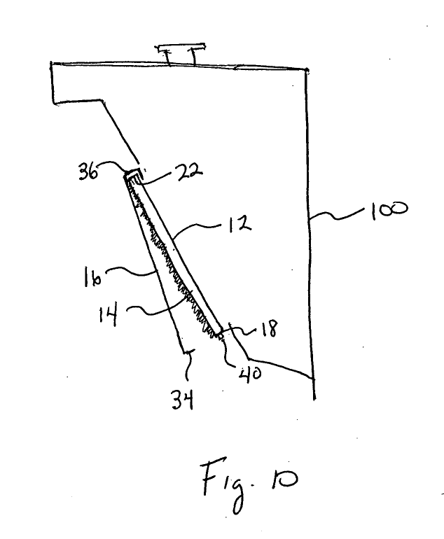

Moreover, while FIGS. 1, 3 and 5 show edge 34 at the top and edge 36 at the bottom of the front frame member, it is recognized that, upon installation in a hood, edge 36 may instead be located at the top and edge 34 located at the bottom. Referring to the side elevation of an installed filter in a hood 100 in FIG. 10, such an arrangement permits the front frame member 16 to hang on the back frame member 12 via the U-channel of edge 36, preventing the front frame member from disengaging the back frame member even if the latch mechanism becomes unlatched.

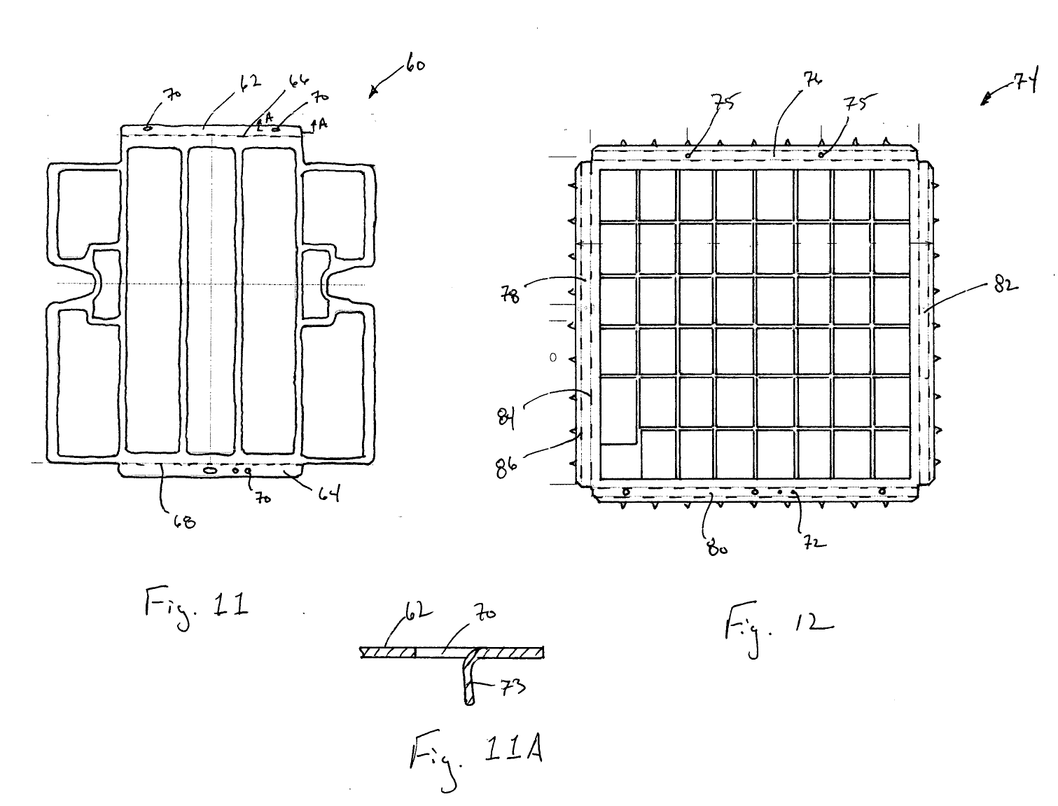

It is to be clearly understood that the above description is intended by way of illustration and example only and is not intended to be taken by way of limitation, and that changes and modifications are possible. For example, referring to FIG. 11, a front frame member 60 does not include a U-shaped channel, but instead includes L-shaped bends at opposite edges 62 and 64 by bending the edges along bend lines 66 and 68. In this embodiment, edge 62 and edge 64 includes openings 70. Openings 70 on edge receive projections 72 on a back frame member 74. Referring to FIG. 11A, edge 62 includes projections 73 that are formed by bending cut through tabs inwardly. The projections 73 serve as locator pins that fit within openings 75 in the back frame member 74. Back frame member 74 includes the U-shaped channels by bending edges 76, 78, 80 and 82 along inner and outer bend lines 84 and 86. Accordingly, other embodiments are within the scope of the following claims.

What is claimed is:

1. A grease filter unit for a kitchen exhaust hood, comprising:
a front frame member;
a back frame member releasably connected to the front frame member; and
a filter material held between the front frame member and the back frame member.

2. The grease filter unit of claim 2 further comprising a latching mechanism that is used to releasably connect the front frame member and the back frame member.

3. The grease filter unit of claim 2, wherein the latching mechanism comprises a latch located on one of the front frame member and the back frame member and a corresponding opening sized to receive the latch located on the other of the front frame member and the back frame member.

4. The grease filter unit of claim 3, wherein the latch is spring biased toward an extended position and is configured to be depressed under manual force to separate the front frame member and the back frame member.

5. The grease filter unit of claim 1, wherein the front frame member includes a first edge and an opposite second edge, the first edge including a U-shaped channel that is sized to receive a first edge of the back frame member.

6. The grease filter unit of claim 5, wherein the second edge includes an L-shaped bend that overlies a second edge of the back frame member.

7. The grease filter unit of claim 1, wherein the back frame member includes an array of teeth disposed about a periphery of the back frame member, the teeth being configured to engage the filter material.

8. The grease filter unit of claim 1, wherein the front frame member has a top edge, a bottom edge and side edges and slats extending from the top edge to the bottom edge, the front frame member including only top to bottom slats within a central region of the front frame member.

9. The grease filter unit of claim 1, wherein one of the front frame member and back frame member includes a locator pin that is received by an opening in the other of the front frame member and back frame member.

10. A method of filtering grease in a kitchen exhaust hood, the method comprising:
attaching a filter material to a back frame member, the back frame member including structure for use in connecting the filter material to the back frame member; and
releasably connecting a front frame member to the back frame member such that the filter material is located between the front frame member and the back frame member.

11. The method of claim 10, wherein the step of connecting the front frame member to the back frame member includes using a latching mechanism to releasably connect the front frame member and the back frame member.

12. The method of claim 11 further comprising inserting a latch located on one of the front frame member and the back frame member within a corresponding opening sized to receive the latch located on the other of the front frame member and the back frame member.

13. The method of claim 12 comprising biasing the latch toward an extended position, the latch configured to be depressed under manual force to separate the front frame member and the back frame member.

14. The method of claim 10, wherein the step of connecting the front frame member to the back frame member comprises inserting an edge of the back frame member within a U-shaped channel of the front frame member.

15. The method of claim 10, wherein the step of attaching the filter material to the back frame member comprises engaging the filter material with teeth disposed about a periphery of the back frame member.

16. The method of claim 10, wherein wherein the front frame member has a top edge, a bottom edge and side edges and slats extending from the top edge to the bottom edge, the front frame member including only top to bottom slats within a central region of the front frame member.
